(19) United States
(12) Patent Application Publication
(10) Pub. No.: US 2024/0095607 A1
(43) Pub. Date: Mar. 21, 2024

(54) TICKET SYSTEM, PROGRAM, AND METHOD

(71) Applicant: Playground Co., Ltd., Tokyo (JP)

(72) Inventor: Keiji ITO, Tokyo (JP)

(73) Assignee: playground Co., Ltd., Tokyo (JP)

(21) Appl. No.: 18/520,964

(22) Filed: Nov. 28, 2023

Related U.S. Application Data
(63) Continuation of application No. PCT/JP2022/016696, filed on Mar. 31, 2022.

(30) Foreign Application Priority Data
May 31, 2021 (JP) 2021-090990

(51) Int. Cl. G06Q 10/02; G06Q 20/40

(52) U.S. Cl. CPC G06Q 10/02; G06Q 20/4014; G06Q 2220/10

(57) ABSTRACT

An apparatus including processing circuitry configured to: detect use of a ticket; and grant a token whose ownership can be clarified to an owner of the ticket in response to the detection of the use of the ticket.

### CROSS-REFERENCE TO RELATED APPLICATIONS

This application is based upon and claims the benefit of priority from the prior Japanese Patent Application No. 2021-090990, filed May 31, 2021 and PCT Patent Application No. PCT/JP2022/16696, the entire contents of all of which are incorporated herein by reference.

### FIELD

The present disclosure relates to a ticket system, an apparatus, and a method.

### BACKGROUND

Conventionally, systems for issuing tickets for events have been known.

It is known a system that encourages the purchase of a ticket for an event by providing a benefit in return for the purchase of the ticket.

However, conventional ticket issuing systems provide benefits to ticket purchasers. For this reason, for example, when the benefit is rare and valuable, people may purchase tickets for the sole purpose of obtaining the benefit and resell the tickets after receiving the benefit. In this case, tickets are not delivered to those who actually want to come to the event, and even if many tickets are sold, the number of visitors to the event venue may be small.

In addition, when in-kind benefits, such as souvenirs, are granted to the visitors in order to solve such a problem, there is a problem that it takes time and effort to manage those items.

By the way, from the standpoint of the event organizer, a large number of visitors to the event venue has many direct benefits, such as improving the excitement of the event, increasing the familiarity of the event performers, increasing the topicality of the event itself, promoting sales of related goods, and obtaining sponsorships. For this reason, a small number of visitors is not acceptable for the event organizer even if tickets are sold, and a large number of visitors to the event venue is a desirable situation for the event organizer. For this reason, there has been a need to effectively motivate people to participate in an event.

An object of the present disclosure to provide a system capable of effectively motivating people to participate in an event.

### BRIEF DESCRIPTION OF THE DRAWINGS

FIG. 1 is a block diagram showing a configuration of a ticket system of the present embodiment.

FIG. 2 is a block diagram showing a configuration of a user terminal of the present embodiment.

FIG. 3 is a block diagram showing a configuration of a ticket management server of the present embodiment.

FIG. 4 is a block diagram showing a configuration of a ticket inspection system of the present embodiment.

FIG. 5 is a block diagram showing an example configuration of an input device connectable to the ticket inspection system of the present embodiment.

FIG. 6 is a diagram showing a configuration of a token management ledger of the present embodiment.

FIG. 7 is an explanatory diagram of the outline of the present embodiment.

FIG. 8A is a diagram showing example data structures of an event database stored in the ticket management server.

FIG. 8B is a diagram showing example data structures of a user database stored in the ticket management server.

FIG. 8C is a diagram showing example data structures of a ticket database stored in the ticket management server.

FIG. 9A is a diagram showing example data structures of an account database stored in an external server.

FIG. 9B is a diagram showing example data structures of a token database stored in an external server.

FIG. 10 is a diagram showing an example data structure of the token management ledger.

FIG. 11 is a flowchart of user registration processing of the present embodiment.

FIG. 12 is a flowchart of ticket issuance processing of the present embodiment.

FIG. 13 is a flowchart of ticket inspection processing of the present embodiment.

FIG. 14 is a flowchart of token granting processing of the present embodiment.

FIG. 15A is a diagram showing example data structures of a benefit ticket database stored in the ticket management server.

FIG. 15B is a diagram showing example data structures of a redemption code database stored in the external server.

FIG. 16 is a flowchart of processing for the user to redeem the benefit ticket.

FIG. 17A is a diagram showing a first screen example of the present embodiment.

FIG. 17B is a diagram showing a second screen example of the present embodiment.

FIG. 18A is a diagram showing a third screen example of the present embodiment.

FIG. 18B is a diagram showing a fourth screen example of the present embodiment.

FIG. 19A is a diagram showing a fifth screen example of the present embodiment.

FIG. 19B is a diagram showing a sixth screen example of the present embodiment.

FIG. 20 is a diagram showing a data structure of a token management ledger 40 according to a first modification.

FIG. 21 is a flowchart of token granting processing according to a second modification.

### DETAILED DESCRIPTION

In general, according to one embodiment, an apparatus comprising processing circuitry configured to: detect use of a ticket; and grant a token whose ownership can be clarified to an owner of the ticket in response to the detection of the use of the ticket.

Hereinafter, an embodiment of the present invention will be described with reference to the drawings. In the drawings illustrating the embodiment, the same constituent elements are denoted by the same reference numeral in principle, and repeated descriptions thereof will be omitted.

### (1) CONFIGURATION OF TICKET SYSTEM 1

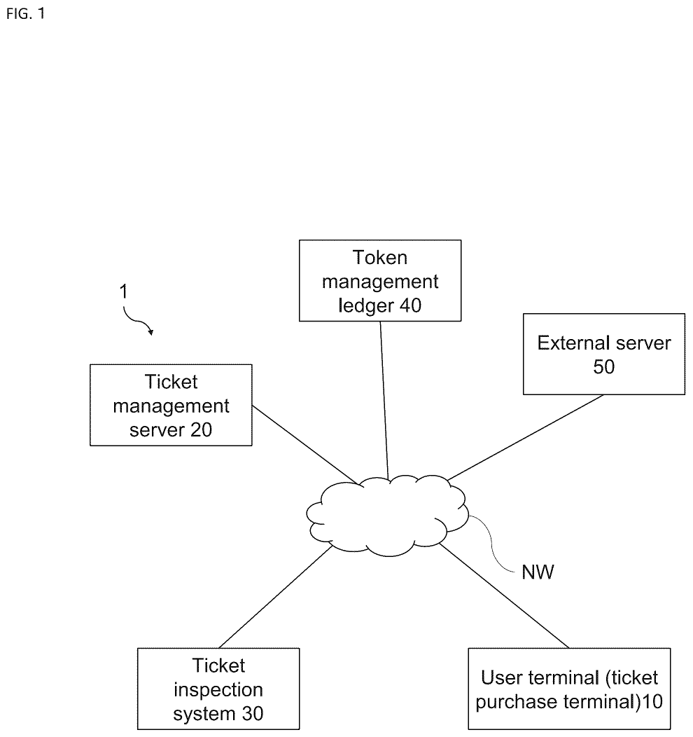

A configuration of a ticket system 1 will be described. FIG. 1 is a block diagram showing a configuration of the ticket system 1 of the present embodiment.

As shown in FIG. 1, the ticket system 1 includes a user terminal 10, a ticket management server 20, and a ticket inspection system 30.

The user terminal 10, the ticket management server 20, and the ticket inspection system 30 are connected via a network (for example, the Internet or an intranet) NW.

The ticket system 1 is connected to a token management ledger 40 and an external server 50 via the network NW.

The user terminal 10 is an information processing apparatus. The user terminal 10 is configured to request the ticket management server 20 for ticket information on a performance. The user terminal 10 may also be referred to as a ticket purchase terminal. In this regard, the user terminal 10 may be an information processing apparatus owned by the ticket purchaser himself or herself or an information processing apparatus installed in a ticket sales office.

In the following description, the information processing apparatus may include various computers such as a smartphone, a tablet terminal, a personal computer, a server computer (such as a Web server, an application server, a database server, or a combination thereof), a wearable device (such as a smart watch or smart glasses), and the like. In the present embodiment, the user terminal 10 will be described with a smartphone, which is a mobile computer connectable to the network NW, taken as an example.

The ticket information is information on a ticket. Specifically, the ticket information may include information that identifies the ticket, information on the authority certified by the ticket (such as information on the performance which the ticket is for), information on the name of the ticket purchaser, information on a feature (such as a facial feature), information on the ticket purchaser (such as a user ID), or a combination thereof, or code information obtained by encoding them (such as a QR code (registered trademark), or other one-dimensional or two-dimensional code).

The ticket may be an image of ticket information displayed on the user terminal 10 held by the user (that is, an electronic ticket). Alternatively, the ticket may be a piece of paper or other medium with ticket information printed thereon.

The ticket includes a ticket for participating in various events, a ticket for receiving various services at a store, a ticket for using transportation such as a railway or an airplane, a ticket for viewing an online event, and the like.

The ticket management server 20 is an information processing apparatus. The ticket management server 20 is configured to issue a ticket (that is, issue ticket information) in response to a request from the user terminal 10. The ticket management server 20 is also configured to manage the issued ticket information.

The ticket inspection system 30 is, for example, an information processing apparatus located at a ticket inspection station when the performance is an event held at various event venues. The ticket inspection station corresponds to the boundary between the event venue and its external space. The ticket inspection system 30 is configured to refer to ticket information held by the ticket presented by a person who intends to enter the event venue (hereinafter referred to as a “visitor”), and determine whether or not the visitor's entry is permitted.

Here, the event venue may be indoors or outdoors. For example, the target space may be an entertainment venue (such as a concert venue, a theater venue, a game venue, an exhibition venue, a store, or a combination thereof), public transportation, an office, or a store.

The ticket inspection system 30 is, for example, an information processing apparatus that manages access to the event when the event is an online event published in the server space. The ticket inspection system 30 is configured to refer to ticket information held by the ticket presented by a person who views the online event (hereinafter referred to as a “visitor”), and determine whether or not the visitor' viewing is permitted.

### (1-1) Configuration of User Terminal 10

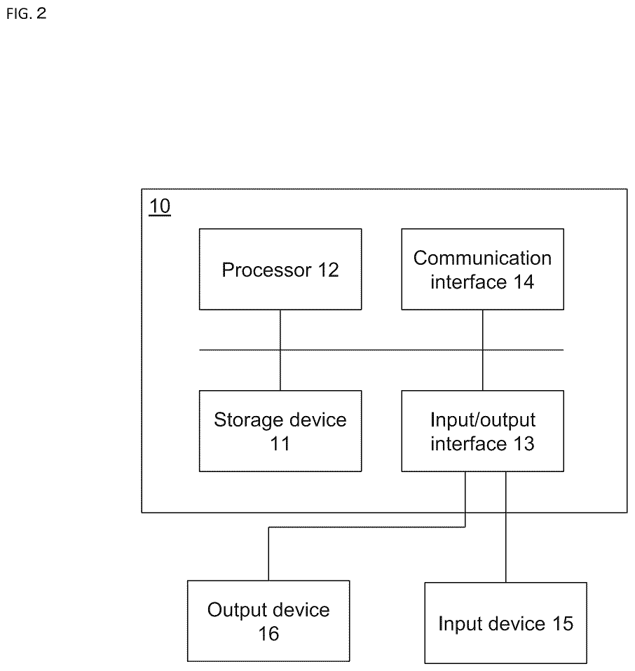

A configuration of the user terminal 10 will be described. FIG. 2 is a block diagram showing a configuration of the ticket purchase terminal of the present embodiment.

As shown in FIG. 2, the user terminal 10 includes a storage device 11, a processor 12, an input/output interface 13, and a communication interface 14. The user terminal 10 is connectable to at least one of the input device 15 and the output device 16.

The storage device 11 is configured to store programs and data. The storage device 11 is, for example, a combination of a read only memory (ROM), a random access memory (RAM), and a storage (such as a flash memory or a hard disk).

The programs include, for example, the following programs:
Operating system (OS) program; and
Program of an application (such as a web browser) that executes information processing.

The data includes, for example, the following data:
Database referred to in information processing; and
Data obtained by executing information processing (i.e., results of executing information processing).

The processor 12 is configured to implement the functions of the user terminal 10 by activating programs stored in the storage device 11. The processor 12 is an example of the computer.

The input/output interface 13 is configured to acquire a signal (such as a user instruction, a sensing signal, or a combination thereof) from the input device 15 and output a signal (such as an image signal, an audio signal, or a combination thereof) to the output device 16.

The input device 15 is, for example, a keyboard, a pointing device, a touch panel, a physical button, a sensor (such as a camera, a vital sensor, or a combination thereof), or a combination thereof.

The output device 16 is, for example, a display, a speaker, a printing device, or a combination thereof.

The communication interface 14 is configured to control communication between the user terminal 10 and an external device (such as at least one of the ticket management server 20, the ticket inspection system 30, the token management ledger 40, and the external server 50).

### (1-2) Configuration of Ticket Management Server 20

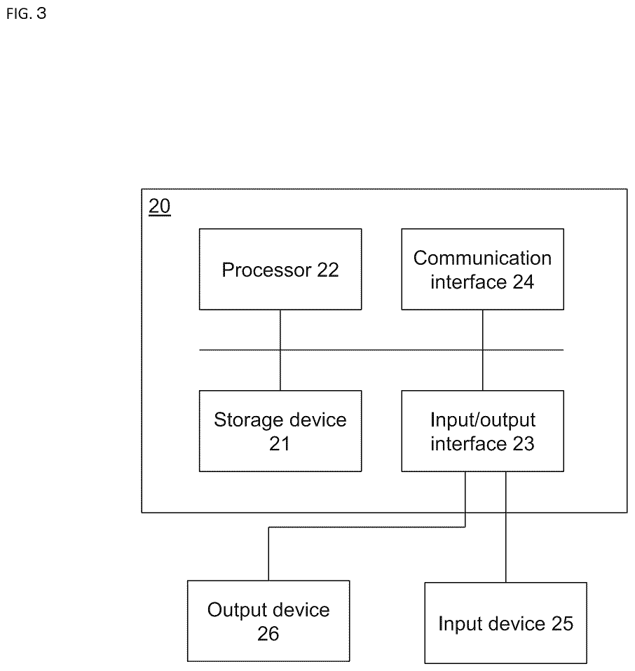

A configuration of the ticket management server 20 will be described. FIG. 3 is a block diagram showing a configuration of the ticket management server 20 of the present embodiment.

As shown in FIG. 3, the ticket management server 20 includes a storage device 21, a processor 22, an input/output interface 23, and a communication interface 24. The ticket management server 20 is connectable to at least one of the input device 25 and the output device 26.

The storage device 21 is configured to store programs and data. The storage device 21 is, for example, a combination of a ROM, a RAM, and a storage (such as a flash memory or a hard disk).

The programs include, for example, the following programs:
OS program; and
Program of an application that executes information processing.

The data includes, for example, the following data:
Database referred to in information processing; and
Results of executing information processing.

The processor 22 is configured to implement the functions of the ticket management server 20 by activating programs stored in the storage device 21. The processor 22 is an example of the computer.

The input/output interface 23 is configured to acquire a signal (such as a user instruction, a sensing signal, or a combination thereof) from the input device 25 and output a signal (such as an image signal, an audio signal, or a combination thereof) to the output device 26.

The input device 25 is, for example, a keyboard, a pointing device, a touch panel, a sensor, or a combination thereof.

The output device 26 is, for example, a display, a speaker, or a combination thereof.

The communication interface 24 is configured to control communication between the ticket management server 20 and an external device (such as at least one of the user terminal 10, the ticket inspection system 30, the token management ledger 40, and the external server 50).

### (1-3) Configuration of Ticket Inspection System 30

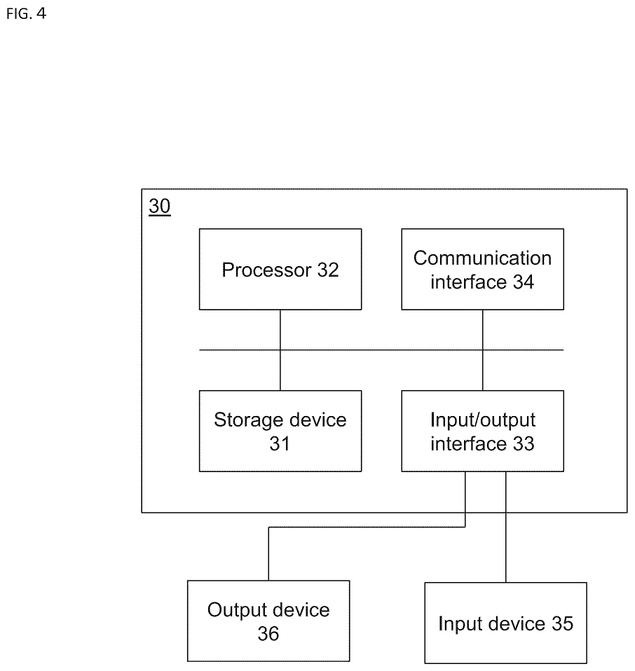

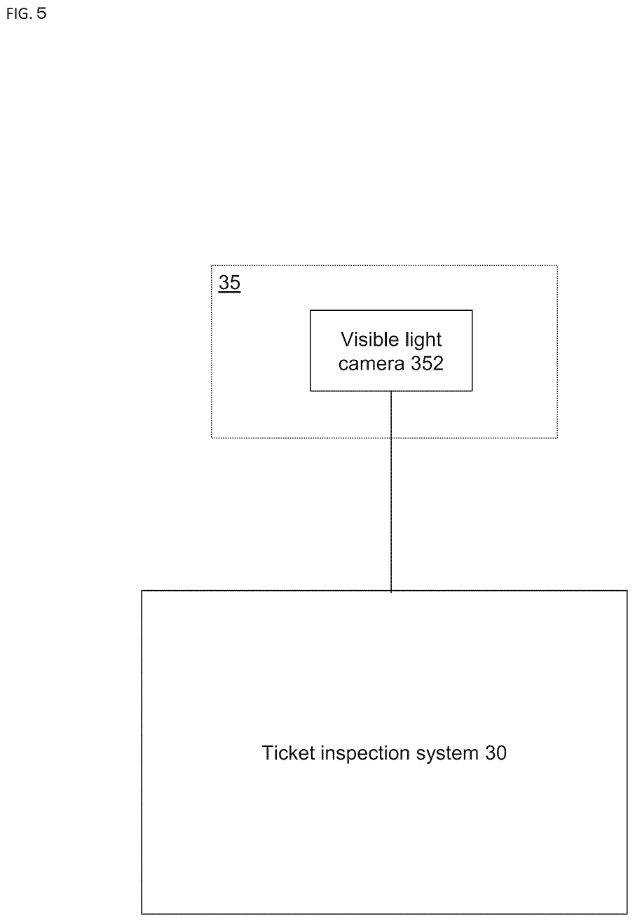

A configuration of the ticket inspection system 30 will be described. FIG. 4 is a block diagram showing a configuration of the ticket inspection system 30 of the present embodiment. FIG. 5 is a block diagram showing an example configuration of the input device 35 connectable to the ticket inspection system 30 of the present embodiment.

As shown in FIG. 4, the ticket inspection system 30 includes a storage device 31, a processor 32, an input/output interface 33, and a communication interface 34. The ticket inspection system 30 is connectable to at least one of the input device 35 and the output device 36.

The storage device 31 is configured to store programs and data. The storage device 31 is, for example, a combination of a ROM, a RAM, and a storage.

The programs include, for example, the following programs:
OS program; and
Program of an application that executes information processing.

The data includes, for example, the following data:
Database referred to in information processing; and
Data obtained by executing information processing.

The processor 32 is configured to implement the functions of the ticket inspection system 30 by activating programs stored in the storage device 31. The processor 32 is an example of the computer.

The input/output interface 33 is configured to acquire a signal (such as a user instruction, a sensing signal, or a combination thereof) from the input device 35 and output a signal (such as an image signal, an audio signal, or a combination thereof) to the output device 36.

The input device 35 is, for example, a keyboard, a pointing device, a touch panel, a sensor (such as a camera, a vital sensor, or a combination thereof), or a combination thereof. As shown in FIG. 5, the input device 35 includes, for example, a visible light camera 352.

The input device 35, alone or in cooperation with the processor 32, implements at least an authentication information acquisition means.

The authentication information acquisition means reads information (hereinafter referred to as “authentication information”) necessary for determining whether or not the visitor's entry is permitted when the visitor presents a ticket. The authentication information includes, for example, at least one of the following:
Ticket information; and
Information on a feature (for example, a facial feature/a voice print/a palm print) of the visitor.

A ticket information area for reading ticket information is defined on the ticket. Ticket information is displayed or printed in the ticket information area.

The authentication information acquisition means can acquire ticket information by a combination of the visible light camera 352 and an application which analyzes the image captured by the visible light camera 352 to extract an image of the ticket information and restores the ticket information from the image of the ticket information. In acquiring the ticket information, information processing such as optical character recognition (OCR) processing or decoding processing is performed as necessary.

The authentication information acquisition means can acquire information on the facial feature of the visitor by a combination of the visible light camera 352 and an application which analyzes the image captured by the visible light camera 352 to extract the image of the face of the visitor and calculates a feature from the image of the face of the visitor.

The images of the ticket and the visitor may be captured simultaneously or sequentially by the same visible light camera 352, or one may be captured by the visible light camera 352 and the other by another visible light camera (not shown).

The output device 36 is, for example, a display, a speaker, an alarm device, a motorized gate, or a combination thereof.

The communication interface 34 is configured to control communication between the ticket inspection system 30 and an external device (such as at least one of the user terminal 10, the ticket management server 20, the token management ledger 40, and the external server 50).

### (1-4) Configuration of Token Management Ledger 40

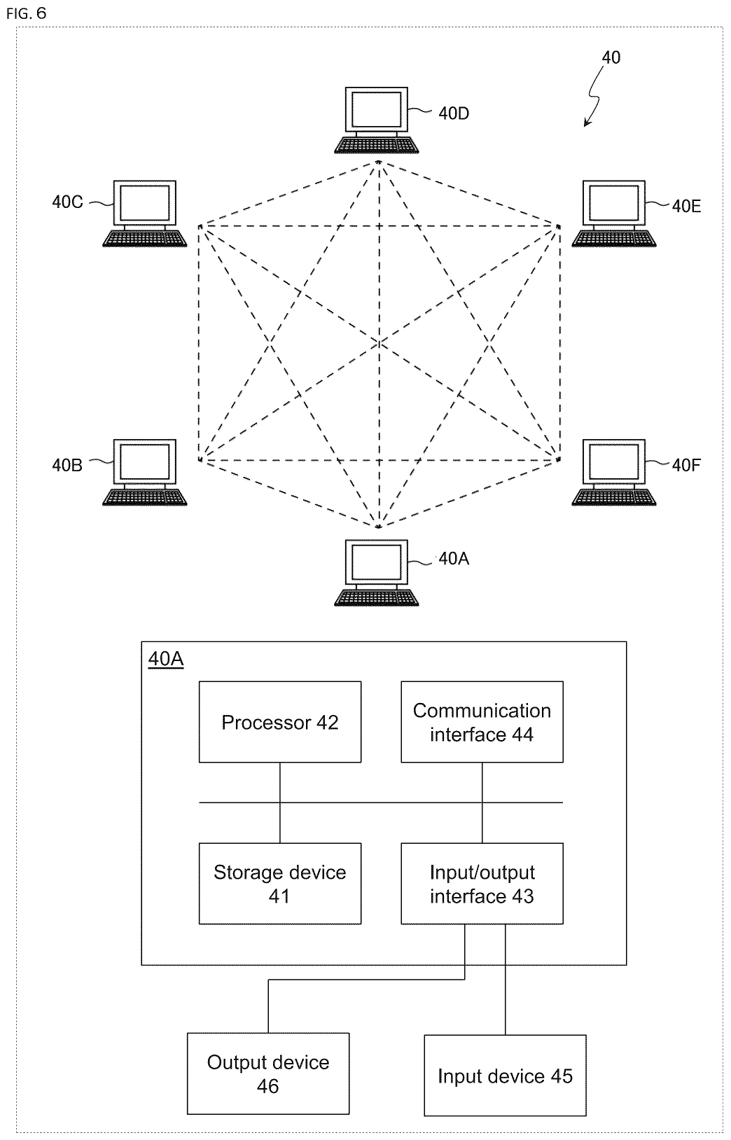

FIG. 6 is a diagram showing a configuration of the token management ledger 40. The token management ledger 40 is a distributed system including signal processors 40A to 40E that function as nodes.

The signal processors 40A to 40E are, for example personal computers connected to a network. In the present embodiment, the network may be a LAN or an open network such as the Internet or a communication network provided by a telecommunications carrier. The signal processors 40A to 40E are connected to the network by wire or wirelessly. The signal processors 40A to 40E communicate with each other using a peer-to-peer method.

The signal processors 40A to 40E implement the token management ledger 40 using blockchain technology. In addition, the signal processors 40A to 40E, for example, any one signal processor 40A of the signal processors 40A to 40E acquires data on a token transaction to be recorded. The signal processor 40A creates a block including the acquired data and adds the block to the blockchain. The signal processor 40A transmits the information of the added block to the other signal processors 40B to 40E. The other signal processors 40B to 40E verify the correctness of the received block, and when the correctness is verified, add the block to the blockchain. The signal processors 40A to 40E determine the blockchain according to, for example, the number of blocks to be linked (the number of approvals). As a result, the same token management ledger 40 is stored in the signal processors 40A to 40E. The data to be stored may be encrypted as appropriate.

The configuration of the token management ledger 40 is not limited to that shown in FIG. 6. For example, the number of the signal processors included in the token management ledger 40 may be any number as long as it is two or more.

The signal processor 40A includes a storage device 41, a processor 42, an input/output interface 43, and a communication interface 44. The signal processor 40A is connectable to at least one of the input device 45 and the output device 46.

The storage device 41 is configured to store programs and data. The storage device 41 is, for example, a combination of a read only memory (ROM), a random access memory (RAM), and a storage (such as a flash memory or a hard disk).

The programs include, for example, the following programs:
Operating system (OS) program; and
Program of an application (such as a web browser) that executes information processing.

The data includes, for example, the following data:
Database referred to in information processing; and
Data obtained by executing information processing (i.e., results of executing information processing).

The processor 42 is configured to implement the functions of the signal processor 40A by activating programs stored in the storage device 41. The processor 42 is an example of the computer.

The input/output interface 43 is configured to acquire a signal (such as a user instruction, a sensing signal, or a combination thereof) from the input device 45 and output a signal (such as an image signal, an audio signal, or a combination thereof) to the output device 46.

The input device 45 is, for example, a keyboard, a pointing device, a touch panel, a physical button, a sensor (such as a camera, a vital sensor, or a combination thereof), or a combination thereof.

The output device 46 is, for example, a display, a speaker, a printing device, or a combination thereof.

The communication interface 44 is configured to control communication between the signal processor 40A and an external device (such as at least one of the user terminal 10, the ticket management server 20, the ticket inspection system 30, and the external server 50).

### (1-5) Configuration of External Server 50

The external server 50 shown in FIG. 1 includes at least a storage unit and a communication interface. The external server 50 is a storage device implemented by, for example, a distributed application (DApp).

The storage unit stores digital contents that constitute the token. The external server 50 is managed by, for example, a content management company that manages digital contents.

The communication interface is configured to control communication between the external server 50 and an external device (at least one of the user terminal 10, the ticket management server 20, the ticket inspection system 30, and the token management ledger 40).

Note that the functions of the external server 50 may be implemented by the ticket management server 20.

### (2) OUTLINE OF EMBODIMENT

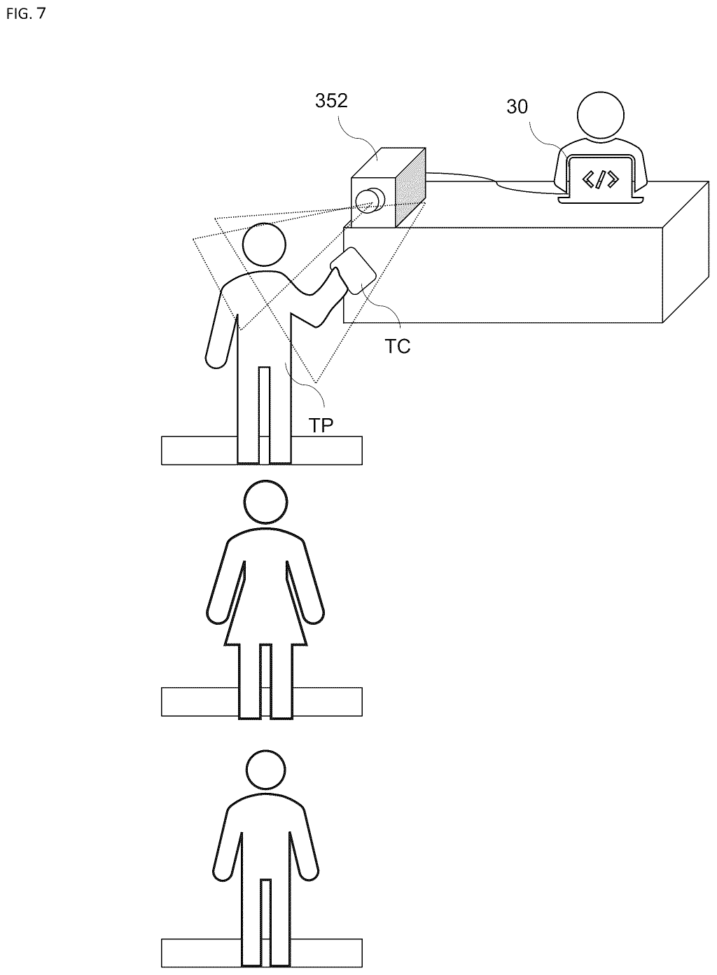

First, an outline of the present embodiment will be described. FIG. 7 is an explanatory diagram of the outline of the present embodiment.

As shown in FIG. 7, the ticket inspection system 30 is located at a ticket inspection station. At the ticket inspection station, a plurality of persons form a line, and ticket inspection is performed for each person in turn.

When a ticket TC is presented by a visitor TP, the visible light camera 352 captures an image of the visitor TP and the ticket TC within the imaging range of the visible light camera 352. The ticket inspection system 30 (specifically, the processor 32) acquires ticket information of the ticket TC and a feature (such as a facial feature) of the visitor TP from the image captured by the visible light camera 352.

Next, the ticket inspection system 30 confirms the ticket information, notifies the visitor who presented the appropriate ticket that his or her entry is permitted, and notifies the ticket management server 20 to that effect. The ticket management server 20 places the ticket into a used state. Placing a ticket in the used state is also referred to as “collecting a ticket”. That is, when a ticket relates to the event held at the event venue, the detection of the use of the ticket is executed by collection of the ticket performed when the visitor visits the event venue.

Note that the use of the ticket means that the user enters the event venue using the ticket.

The ticket inspection system 30 compares the facial feature of the visitor (TP) acquired from the visible light camera 352 with the facial feature of the owner of the ticket stored in advance in the ticket management server 20 to confirm that the owner and user of the ticket match. When the identity of the owner and user of the ticket is confirmed, the ticket management server 20 grants a token to the owner of the ticket.

That is, the ticket system 1 grants a token whose ownership is clarified to the owner of the ticket whose use has been detected. The token refers to data with an asset value, which is granted to the owner of the ticket (in other words, the user of the ticket, that is, the visitor) as a benefit of the ticket. The owner of the token in the present embodiment is recorded in the token management ledger 40 to be described later, so that the ownership thereof can be clarified. The token of the present invention includes a fungible token and a non-fungible token.

The fungible token refers to data treated as an asset equivalent to money, such as virtual currency or points.

The non-fungible token includes, for example, text data commented on a social networking service (SNS). In this case, the text data itself can be copied at will by a third party. On the other hand, the ownership of the original text data on the SNS does not change even if the text data itself is copied and diverted. The token includes, for example, digital contents such as a digital image, a digital video, and a digital sound source which are granted as a benefit. Such digital contents are stored in the external server 50 shown in FIG. 1. In the present embodiment, a configuration in which a non-fungible token is handled as a token will be described as an example.

The token of the present invention can be transferred at will based on an agreement between users. The token may be transferred in exchange for another token or with the provision of money or other value.

Since the ticket system 1 grants a token to the user of the ticket (the visitor) in the above-described manner, the user who wants to be granted a token needs not only to purchase the ticket but also to visit the event venue. This encourages users who want to collect tokens to visit the venue. Further, in the ticket system 1, the identity of the visitor and the owner is checked, which discourages resale behavior such as acquiring a token by purchasing a ticket and then transferring the ticket to another person.

### (3) DATA STRUCTURES

The databases of the present embodiment will be described. The following databases are stored in the storage device 21 of the ticket management server 20 and the external server 50. However, a copy of at least a part of the following databases may also be stored in the storage device 31 of the ticket inspection system 30.

### (3-1) Event Database

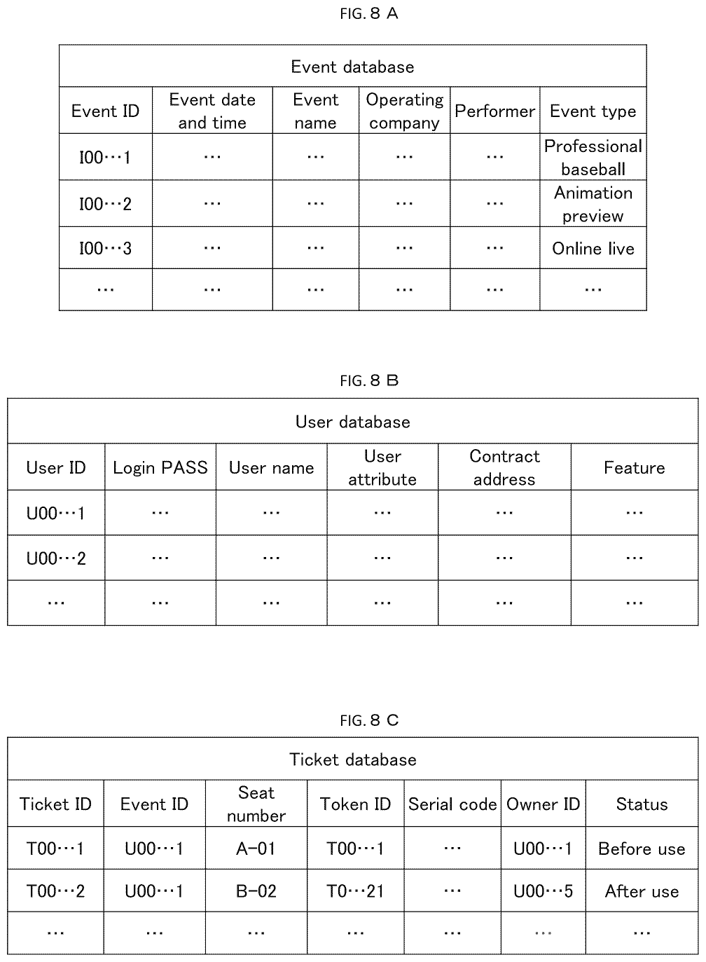

An example configuration of the event database will be described. FIG. 8A to 8C are diagrams showing example data structures of an event database, a user database, and a ticket database stored in the ticket management server 20.

The event database shown in FIG. 8A stores event information.

As shown in FIG. 8A, the event database includes an “event ID” field, an “event date and time” field, an “event name” field, an “operating company” field, a “performer” field, and an “event type” field.

The “event ID” field stores an event ID. The event ID is information for identifying various events.

The “event date and time” field stores the date and time of the event. The event date and time is information indicating the date and time when the event identified by the event ID is held.

The “event name” field stores an event name. The event name is information indicating the name of the event identified by the event ID.

The “operating company” field stores information on the operating company. The information on the operating company is information indicating the operating company of the event identified by the event ID. The information on the operating company may include, in addition to the name of the operating company, the address of the operating company and the contact information of the person in charge.

The “performer” field stores performer information. The performer information is information indicating a performer in the event identified by the event ID. The performer information includes an individual or a group (group name, team name, band name, and the like).

The “event type” field stores information on the event type. The information on the event type is information indicating the outline of the event identified by the event ID. For example, the event type includes “professional baseball”, “animation preview”, “online live”, and the like.

### (3-2) User Database

An example configuration of the user database will be described.

User information is stored in the user database shown in FIG. 8B.

As shown in FIG. 8B, the user database includes a “user ID” field, a “login PASS” field, a “user name” field, a “user attribute” field, a “contact address” field, and a “feature” field.

The “user ID” field stores a user ID. The item “user ID” is information for identifying the user.

The “login PASS” field stores information on a login password that the user is required to enter when logging in to the ticket management server 20.

The “user name” field stores the name of the user corresponding to the user ID.

The “user attribute” field stores information indicating the attribute of the user corresponding to the user ID. The attribute of the user includes age, date of birth, gender, occupation, nationality, area of residence, or a combination thereof.

The “contact address” field stores information indicating the contact address of the user corresponding to the user ID. The contact information may be, for example, an email address, a phone number, account information for a social networking service (SNS) or other messaging-enabled application, or a combination thereof. The contact information is not limited to the examples given here, and may include any type of information that can be used to send a real-time notification to a visitor via the user terminal 10.

The “feature” field stores the facial feature of the user corresponding to the user ID. The facial feature of the user is extracted from a captured image of the face of the user.

### (3-3) Ticket Database

An example configuration of the ticket database will be described.

Ticket information is stored in the ticket database shown in FIG. 8C.

As shown in FIG. 8C, the user database includes a “ticket ID” field, an “event ID” field, a “seat number” field, a “token ID” field, a “serial code” field, an “owner ID” field, and a “status” field.

The “ticket ID” field stores a ticket ID. The ticket ID is information for identifying the ticket.

The “event ID” field stores an event ID of the event corresponding to the ticket ID.

The “seat number” field stores information for identifying the seat corresponding to the ticket ID. The seat number is information on an assigned seat (an example of the “area”) at the event venue. When there is no seat as in an online event, the seat number ID may be omitted.

The “token ID” field stores a token ID for identifying a token to be granted as a benefit of the ticket corresponding to the ticket ID.

The “serial code ID” field stores a serial code required to be entered to receive the token corresponding to the token ID. The serial code is an identifier composed of a predetermined character string, which is set to approve the granting of the token.

The “owner ID” field stores a user ID indicating the owner of the ticket corresponding to the ticket ID. The ticket owner is, in a primitive sense, the purchaser of the ticket. Transfer of the ticket after purchase makes the transferee user the ticket owner.

The “status” field stores information indicating the state of the ticket corresponding to the ticket ID. The state of the ticket includes “before use” and “after use”. After the ticket is collected, the state of the ticket is rewritten as “after use”.

### (3-4) Account Database

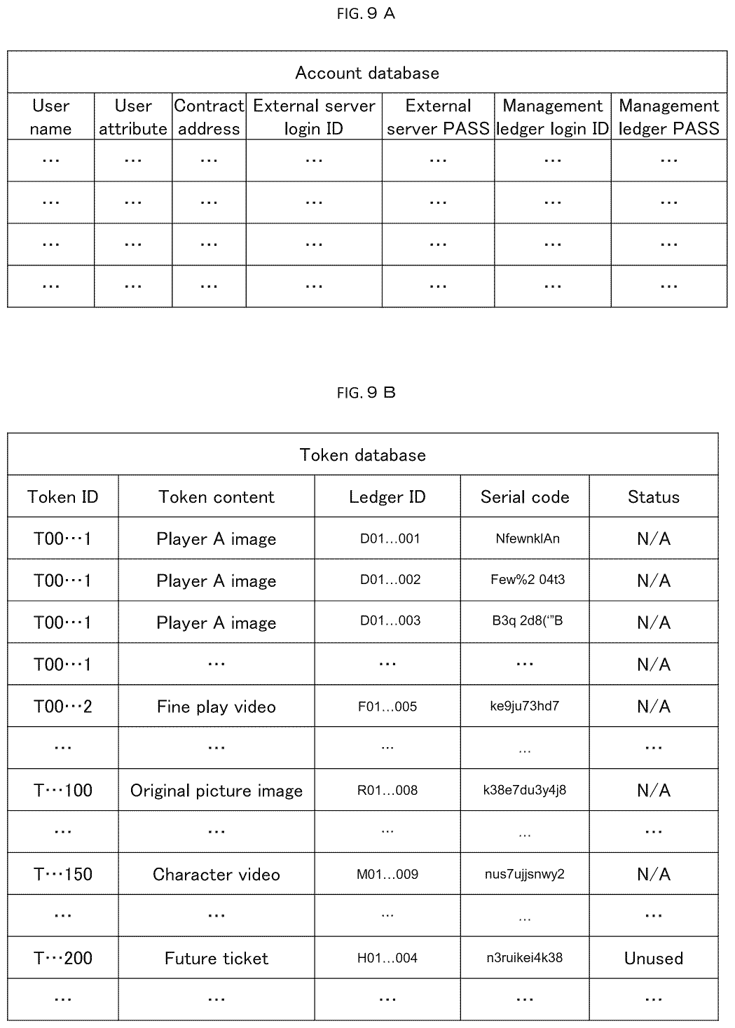

FIGS. 9A and 9B are diagrams showing example data structures of an account database and a token database stored in the external server 50.

FIG. 9A is a diagram showing an example data structure of the account database stored in the external server 50.

The account database shown in FIG. 9A stores account information used for the user to receive a token.

As shown in FIG. 9A, the account database includes a “user name” field, a “user attribute” field, a “contact address” field, an “external server login ID” field, an “external server login PASS” field, a “management ledger login ID” field, and a “management ledger PASS” field.

The “user name” field stores the name of the user.

The “user attribute” field stores information indicating the attribute of the user corresponding to the user name. The attribute of the user includes age, date of birth, gender, occupation, nationality, area of residence, or a combination thereof.

The “contact address” field stores information indicating the contact address of the user corresponding to the user name. The contact information may be, for example, an email address, a phone number, account information for a social networking service (SNS) or other messaging-enabled application, or a combination thereof. The contact information is not limited to the examples given here, and may include any type of information that can be used to send a real-time notification to a visitor via the user terminal 10.

The “external server login ID” field stores a user ID in the external server 50 of the user corresponding to the user name. That is, the “external server login ID” is a login ID that the user is required to enter when logging in to the external server 50.

The “external server PASS” field stores a login password that the user corresponding to the user name is required to enter when logging in to the external server 50.

The “management ledger login ID” field stores a user ID in the token management ledger 40 of the user corresponding to the user name. That is, the “management ledger login ID” is a login ID that the user or the external server 50 is required to enter when logging in to the token management ledger 40.

The “management ledger PASS” field stores a password that the external server 50 enters into the token management ledger 40 when rewriting the contents of the token management ledger 40 based on an entry from the user. Alternatively, the user himself or herself can directly rewrite the token management ledger 40 using the management ledger login ID and the management ledger PASS.

### (3-5) Token Database

FIG. 9B is a diagram showing an example data structure of the token database stored in the external server 50.

The token database shown in FIG. 9B stores information on tokens.

As shown in FIG. 9B, the token database includes a “token ID” field, a “token content” field, a “ledger ID” field, a “serial code” field, and a “status” field.

The “token ID” field stores a token ID. The token ID is information for identifying the token. The token ID is a number assigned one for each token content. For example, when a player image of a baseball player A is set as the digital content of a token, one token ID is set for the player image of the player A. In contrast, ledger IDs to be described later are set in quantity corresponding to the quantity of tokens granted. Therefore, a plurality of ledger IDs are set for a single token ID.

The “token content” field includes information indicating the content of the token corresponding to the token ID. The information indicating the content of the token is information indicating the content of the token granted as a benefit of a ticket of the event identified by the event ID. Examples of the content of the token include “player image/video”, “character image/video”, “bonus sound source”, and the like.

The “ledger ID” stores a management ID as a management ledger in the token management ledger 40. That is, the “ledger ID” is an ID set for each token ownership. The “ledger ID” may be rephrased as a blockchain ID in the present embodiment. As the “ledger ID”, a unique value is set for each token ownership.

The “serial code ID” field stores a serial code that is required to be entered to receive the token.

The “status” field stores information indicating the status of the token recorded in the ledger corresponding to the ledger ID. The status of the token is information indicating whether the token has already been used. The use of a token refers to the redemption of the token for a preset benefit. The redemption of a token for a benefit may or may not involve the transfer of the token. The redemption of a token for a benefit will be described later.

### (3-5) Token Management Ledger 40 and External Server 50

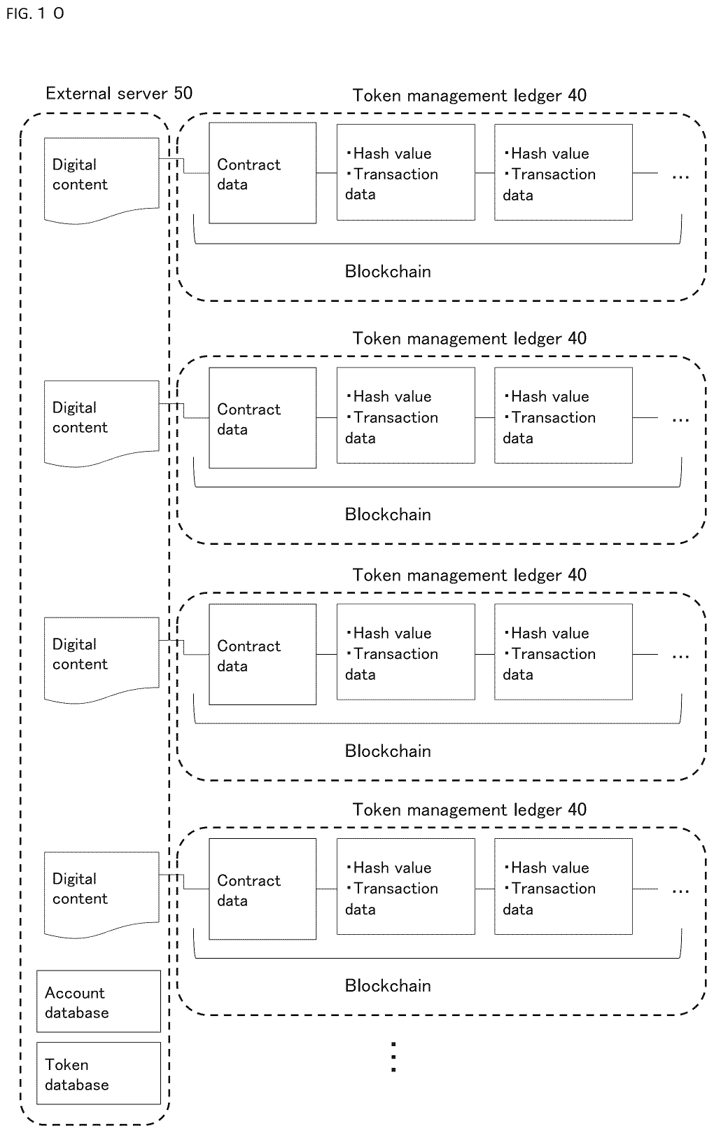

As shown in FIG. 10, the token management ledger 40 is associated with a digital content recorded in the external server 50. The token management ledger 40 is implemented by a blockchain which is a distributed management ledger. In other words, tokens are managed by a distributed management ledger. The transaction history of each token associated with the transfer of ownership, which will be described later, can be referred to. By referring to the entire transaction history of a token, the owner of the token can be identified.

The blockchain is composed of a block constituting contract data and a block including at least a hash value and transaction data. When a token is transferred between users, new transaction data is generated, and a new block is added after the verification by the signal processors 40A to 40E shown in FIG. 6.

Note that the blockchain may have a configuration involving a plurality of layers, such as using a public blockchain and a private blockchain, recording the transaction history of normal transactions on the private blockchain, and periodically reflecting the latest information on the public blockchain.

### (4) TICKET PROCESSING

Ticket processing of the present embodiment will be described.

### (4-1) User Registration Processing

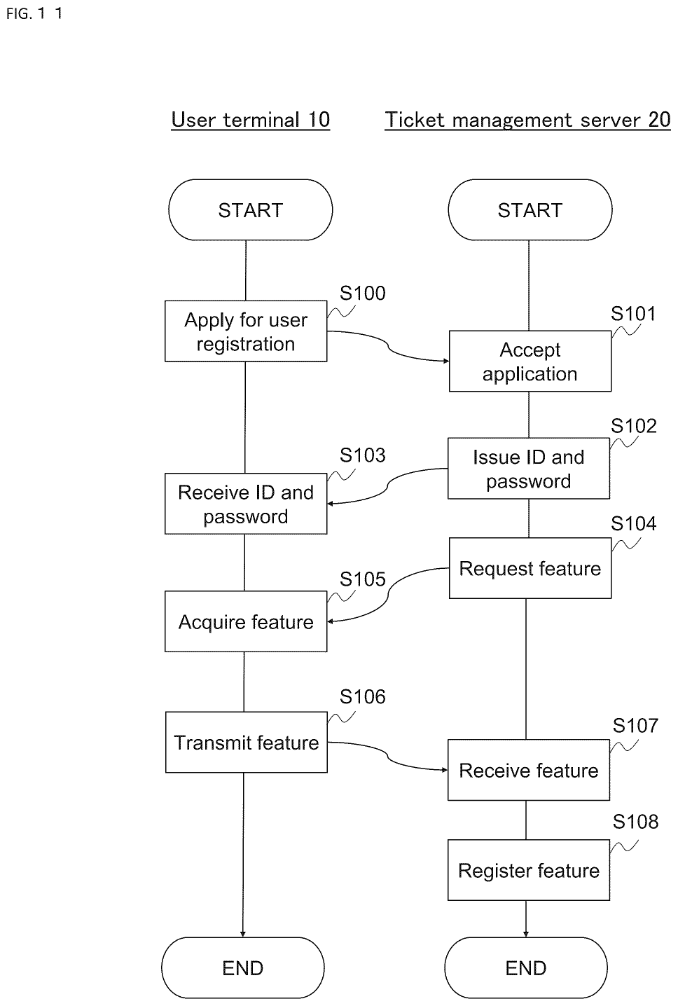

User registration processing of the present embodiment will be described. FIG. 11 is a flowchart of user registration of the present embodiment.

As shown in FIG. 11, the user first operates the user terminal 10 to enter personal information such as his or her name to apply for user registration (step S100).

After step S100, the ticket management server 20 accepts the application for the user registration (step S101).

After step S101, the ticket management server 20 issues a user ID and a login password (step S102). At this time, the ticket management server 20 records the personal information entered by the user, the user ID, and the password as a new record in the user database.

After step S102, the user terminal 10 receives the issued user ID and login password (step S103).

After step S102, the ticket management server 20 requests the user terminal 10 to input a feature (step S104). Specifically, the ticket management server 20 requests an input of a captured image of the face of the user.

After step S104, the user operates the user terminal 10 to acquire the feature (step S105). Specifically, the user captures an image of his or her own face using the input device 15 (visible light camera) of the user terminal 10. The processor 12 performs an operation on the acquired image data to acquire a feature (for example, a facial feature) of the purchaser of the ticket.

After step S105, the user terminal 10 transmits the acquired feature, that is, the user s face image to the ticket management server 20 (step S106).

After step S106, the ticket management server 20 receives the feature transmitted from the user terminal 10 (step S107).

After step S107, the ticket management server 20 registers the received feature in the user database (step S108).

This completes the user registration processing.

### (4-2) Ticket Issuance Processing

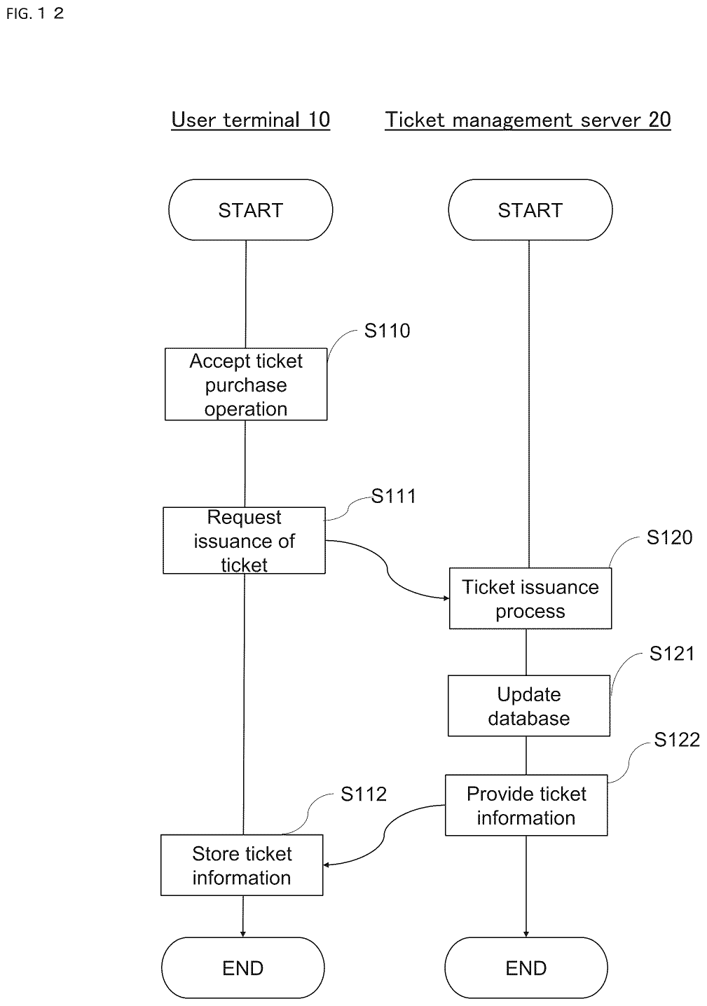

FIG. 12 is a flowchart of the ticket issuance processing of the present embodiment.

As shown in FIG. 12, the user terminal 10 accepts a purchase operation (S110).

Specifically, the processor 12 accepts a purchase operation performed on the input device 15, via the input/output interface 13.

The operator of the user terminal 10 is not limited to the purchaser of the ticket, and may be a person who operates the user terminal 10 on behalf of the purchaser (such as a clerk at a ticket sales office).

The purchase operation may include, for example, entering a user ID, selecting a performance, selecting a date and time, selecting a seat type, pressing a purchase button (button object or physical button), or a combination thereof.

After step S111, the user terminal 10 requests issuance of a ticket (step S111).

Specifically, the processor 12 generates a ticket issuance request by referring to the content of the purchase operation accepted in step S110 and the feature acquired in step S111. The ticket issuance request includes, for example, information designating the type of ticket for which issuance of a ticket is requested (such as information designating a performance, a date and time, and a seat type), and a feature and a user ID of the purchaser of the ticket. The processor 12 transmits the ticket issuance request to the ticket management server 20 via the communication interface 14.

After step S111, the ticket management server 20 performs ticket issuance processing (step S120). Specifically, the processor 22 of the ticket management server 20 assigns a ticket to be sold based on the information of the purchaser transmitted from the user terminal 10.

After step S120, the ticket management server 20 updates the database (step S121).

Specifically, the processor 22 newly registers the user ID included in the ticket issuance request and the reference feature ID identified in step S120 in the ticket database (FIG. 8C) in association with an unissued ticket ID. This makes it possible to identify the purchaser of the ticket and the reference feature based on the ticket ID.

The processor 22 also updates the user database (FIG. 8B) using the feature of the purchaser transmitted from the user terminal 10. If the feature of the user has already been stored, this process may be omitted.

After step S121, the ticket management server 20 provides ticket information (step S122).

Specifically, the processor 22 generates ticket information with reference to the updated contents of the database in step S121. The ticket information includes the ticket ID newly registered in step S121. In addition, the ticket information may include at least one of the reference feature ID identified in step S121 and the user ID of the ticket purchaser. Some or all of the information included in the ticket information may be encoded in, for example, a QR code (registered trademark) or other code information. The processor 22 provides the generated ticket information to the purchaser of the ticket. As an example, the processor 22 transmits it to the user terminal 10 via the communication interface 24.

After step S122, the user terminal 10 stores the ticket information (step S112).

Specifically, the processor 12 acquires the ticket information provided in step S122. The processor 12 stores the acquired ticket information in the storage device 11. As a result, the processor 12 can display the ticket information as necessary. In addition, the processor 12 may optionally execute at least one of the following:
Causing the output device 16 (printing device) to print the ticket information on paper or other media; and
Causing the communication interface 14 to transmit the ticket information to the user terminal 10 of the purchaser of the ticket.

### (4-3) Ticket Inspection Processing

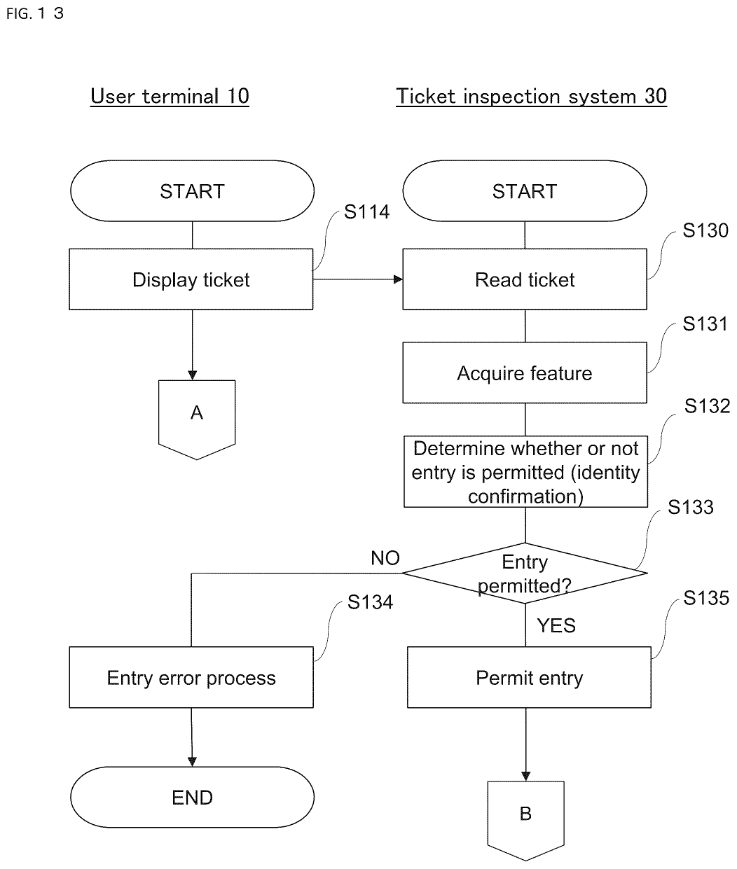

Ticket inspection processing of the present embodiment will be described. FIG. 13 is a flowchart of ticket inspection processing of the present embodiment.

As shown in FIG. 13, the user who visits the event venue operates the user terminal 10 to display the ticket on the user terminal 10 (step S114).

Specifically, the processor 12 of the user terminal 10 causes the ticket information stored in the storage device 11 to be displayed.

After step S114, the ticket inspection system 30 reads the ticket (S130).

Specifically, when the visitor presents the ticket, the processor 32 reads the ticket information in cooperation with the visible light camera 352 (authentication information acquisition means).

In step S130, the processor 32 may cause the output device 36 (display) to display the image captured by the visible light camera 352 for the visitor. This makes it possible to give feedback to the visitor on how the image of the ticket is being captured, and to encourage the visitor to finely adjust the position and posture of the ticket.

Further, the ticket inspection system 30 acquires a feature (S131).

Specifically, when the visitor presents the ticket, the processor 32 cooperates with the visible light camera 352 to acquire the feature (for example, facial feature) of the visitor.

In step S131, the processor 32 may cause the output device 36 (display) to display the image captured by the visible light camera 352 for the visitor. This makes it possible to give feedback to the visitor on how the image of himself or herself is being captured, and to encourage the visitor to finely adjust the position and posture of himself or herself.

The ticket inspection system 30 may execute step S130 and step S131 in a different order from that in FIG. 13. As an example, the ticket inspection system 30 may execute more than one of these steps simultaneously.

After step S130 and step S131, the ticket inspection system 30 determines whether or not entry is permitted (S132).

Specifically, the processor 32 refers to the ticket information read in step S130 to determine whether or not the visitor's entry is permitted.

Specifically, the processor 32 queries the ticket database for the read ticket information, and determines whether or not the ticket information is appropriate ticket information with the authority for entry. At this time, the processor 32 confirms the identity of the visitor and the ticket owner. That is, the processor 32 refers to the owner ID of the ticket recorded in the ticket database for a comparison with the feature of the user associated with the user ID registered in the user database, and determines whether or not the ticket owner (purchaser) is the visitor.

In step S133, when the read ticket information is not appropriate ticket information or when the identity of the visitor and the ticket owner cannot be confirmed (No in step S133), the ticket inspection system 30 executes an entry error process (S134).

Specifically, the processor 32 performs at least one of the following processes when it determines in step S133 that the entry of the visitor is to be rejected:
Issuing an alarm (for example, by lighting a lamp, outputting a predetermined sound, displaying a predetermined screen, or a combination thereof, thereby making the visitor and the attendant perceive that the entry of the visitor has been rejected, and urging the attendant to provide aftercare); and
Closing the gate (for example, closing the motorized gate bars or flap doors to physically prevent the visitor from entering).

Note that, from the viewpoint of preventing stagnation near the ticket inspection system 30, the aftercare by the attendant may be provided after the visitor enters the target space for convenience. Aftercare by the attendant may include interaction to determine whether the visitor is the true purchaser of the ticket. As an example, the attendant may ask the visitor for the attribute information of the visitor, the contact information of the visitor, the purchase place of the ticket, the purchase date of the ticket, or a combination thereof and compare them with the ticket information.

After step S134, the ticket inspection processing in FIG. 13 ends.

In step S133, when the read ticket information is appropriate ticket information and the identity of the visitor and the ticket owner can be confirmed (Yes in step S133), the ticket inspection system 30 permits entry (S135), that is, a so-called “ticket collection process”.

Specifically, the processor 32 performs at least one of the following processes when it determines in step S133 that the entry of the visitor is to be permitted:
Notifying that the entry is permitted (for example, by lighting of a lamp, outputting a predetermined sound, displaying a predetermined screen, or a combination thereof, thereby making the visitor and the attendant perceive that the entry of the visitor has been permitted); and
Opening the gate (for example, opening the motorized gate bars or flap doors to encourage the visitor to enter).

The processor 32 may create or update a check-in list during step S135.

The check-in list is information on a list of results of the ticket inspection processing on the respective visitors. The check-in list includes at least one of the following elements as an example:
Check-in time;
Ticket ID of the ticket presented by the visitor;
User ID associated with the ticket ID;
User name associated with the user ID;
Result of determination on whether or not entry is permitted (step S133) (entry permitted/entry rejected); and
Area (e.g., reserved seat) assigned to the user in the target space.

### (4-4) Token Granting Processing

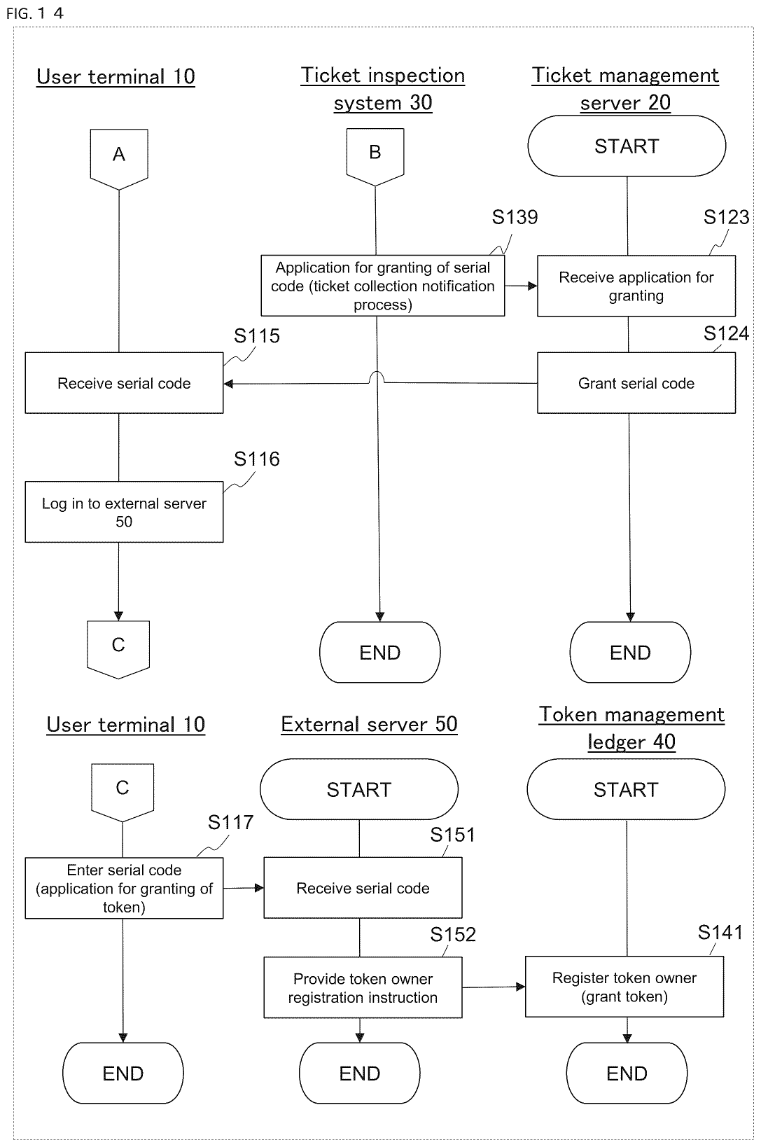

Token granting processing of the present embodiment will be described. FIG. 14 is a flowchart of token granting processing of the present embodiment.

In granting a token, the use first applies to the ticket management server 20 for granting of a serial code (step S139). The application for granting of a serial code may be made together with a notification that the ticket has been used (ticket collection notification).

Specifically, the processor 32 of the ticket inspection system 30 identifies the user ID of the ticket owner and the used ticket ID, and transmits to the ticket management server 20 a request for granting of a serial code to the user.

After step S139, the ticket management server 20 receives the application for granting of a serial code (step S123). Specifically, the processor 22 of the ticket management server 20 receives the user ID to which a serial code is to be granted from the ticket inspection system 3. At this time, the ticket management server 20 simultaneously receives a notification that the collected ticket is in the used state. The ticket management server 20 changes the “status” field of the ticket in the ticket database to “used”.

After step S123, the ticket management server 20 grants a serial code to the user terminal 10 (step S124). Specifically, the processor 22 of the ticket management server 20 refers to the ticket database and identifies a token to be granted and a serial code set for the token to be granted. The processor 22 transmits the identified serial code to the user terminal 10 used by the user to whom the serial code is to be granted.

After step S124, the user terminal 10 receives the serial code (step S115). Specifically, the processor 12 of the user terminal 10 receives from the ticket management server 20 a serial code corresponding to the token to be granted. For example, the serial code may be granted, for example, in the form of being written on the face of an electronic ticket. That is, the face of the electronic ticket may be rewritten to include the serial code.

After step S115, the user operates the user terminal 10 to log in to the external server 50 (step S116). Specifically, the user logs in to the external server 50 by operating the user terminal 10 and inputting an external server login ID and an external server login PASS.

After step S116, the user inputs the serial code to an input form output from the external server 50 (step S117).

After step S117, the user terminal 10 transmits the serial code to the external server 50. The processor 12 of the user terminal 10 transmits the serial code input by the user to the ticket management server 20. In this way, an application for granting of a token is made.

After step S117, the external server 50 receives the serial code (step S151). At this time, the external server 50 queries its own token database for the input serial code.

In step S151, when the serial code is an appropriate code, the external server 50 transmits a token owner registration instruction to the token management ledger 40 (step S152). At this time, the external server 50 refers to the account database to refer to a management ledger login ID and a management ledger PASS corresponding to the external server login ID, use these pieces of information to access the token management ledger 40, and provides an instruction to rewrite the management ledger. The external server ID transmits the information of the ledger ID associated with the serial code to the token management ledger 40 in the rewriting instruction.

After step S152, the token management ledger 40 registers information on the owner of the token (for example, wallet information that is information for identifying the user who visited the event venue on the blockchain) (step S141). At this time, the token management ledger 40 identifies the ledger to be recorded based on the ledger ID input from the external server 50, and identifies the user based on the management ledger login ID input from the external server 50. Thus, a block in which the ledger login ID is recorded is added as new transaction data on the blockchain.

This clarifies the owner of the token. In other words, through this process, a token is granted to a user who has visited the event venue.

This completes the token granting processing.

### (5) OTHER FUNCTIONS

Next, other functions of the ticket system 1 will be described.

The ticket management server 20 provides a benefit to the user who owns a token by using a token as a voucher. The benefit is, for example, a ticket for a future event, a special discount coupon, a preferential ticket purchase privilege, or merchandise. A process of redeeming a ticket (benefit ticket) provided as a benefit using such a token as a voucher will be described. Note that some of the general tickets are allocated for the benefit tickets. That is, some of the tickets of events are provided to users as benefits by the redemption process to be described below.

The benefit ticket is a ticket of an event that will be hosted after a certain period of time (for example, several months or several years) has elapsed from the event of the ticket to which the token was granted. During this period, the user can transfer the token to another user. That is, the ticket system 1 changes the owner of the token to another user in response to an instruction from the owner to whom the token was granted. At this time, the record of the token management ledger 40 is rewritten via the external server 50.

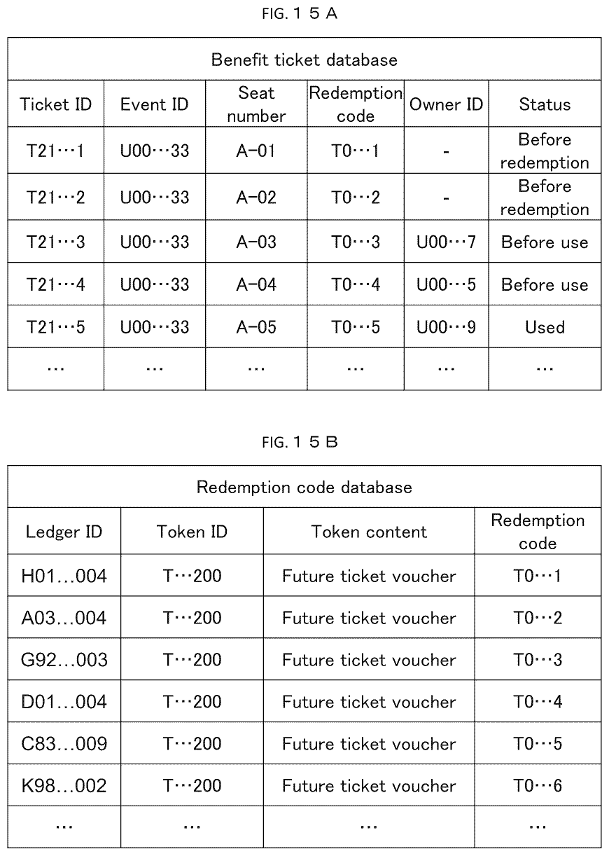

FIGS. 15A and 15B are diagrams showing example data structures of a benefit ticket database stored in the ticket management server 20 and a redemption code database stored in the external server 50. These databases are generated, for example, at the timing when the event at which the benefit ticket is used is about to be held.

FIG. 15A is a diagram showing an example data structure of the benefit ticket database stored in the ticket management server 20.

As shown in FIG. 15A, the benefit ticket database includes a “ticket ID” field, an “event ID” field, a “seat number” field, a “redemption code” field, an “owner ID” field, and a “status” field.

The “ticket ID” field stores an ID of a ticket that is a benefit exchanged for a voucher. In this description, the ticket is referred to as a benefit ticket, but the benefit ticket may be designed such that some general tickets are allocated as benefit tickets.

The “event ID” field stores an ID of the event corresponding to the ticket ID. In this description, an ID of an event of the benefit is stored.

The “seat number” field stores the seat number of the benefit ticket corresponding to the ticket ID.

The “redemption code” field stores information on a redemption code that the user is required to enter when redeeming the benefit ticket corresponding to the ticket ID.

The “owner ID” field stores the user ID of the owner of the benefit ticket corresponding to the ticket ID.

The “status ID” field stores the state of the benefit ticket corresponding to the ticket ID. The state of the benefit ticket is “before redemption”, “before use”, and “used”. The status “before redemption” means that the benefit ticket has not been redeemed yet. The status “before use” indicates a state in which the benefit ticket has not been used, that is, a state in which the owner of the benefit ticket has not visited the event venue. The status “used” indicates a state in which the benefit ticket has been used, that is, a state in which the owner of the benefit ticket has visited the event venue and the ticket has been collected.

FIG. 15B is a diagram showing an example data structure of the redemption code database stored in the external server 50.

As shown in FIG. 15B, the benefit ticket database includes a “ledger ID” field, a “token ID” field, a “token content” field, and an “redemption code” field.

The “ledger ID” field stores the token management ID in the token management ledger 40.

The “token ID” field stores a token ID for managing the type of token.

The “token content” field stores the content of the token whose ownership is managed in the ledger corresponding to the ledger ID. In practice, instead of the “future ticket voucher” shown in this figure, a specific event name such as “voucher for the Budokan live concert scheduled to be held on yymmdd (date)” or “voucher for the Osaka performance of the national tour scheduled to be held in year xxxx” is stored. Alternatively, the voucher may be flexible in scope, such as “preferential purchase privilege for 10th anniversary live”, “voucher for Budokan live”, “one-time preferential purchase privilege for any live hosted by XX office”, and “preferential purchase privilege for special merchandise”.

The “redemption code” field stores information on a redemption code that the user is required to enter when redeeming the benefit ticket corresponding to the ticket ID. In other words, information indicating the authority of the user when acquiring the benefit ticket using the token as a voucher is stored.

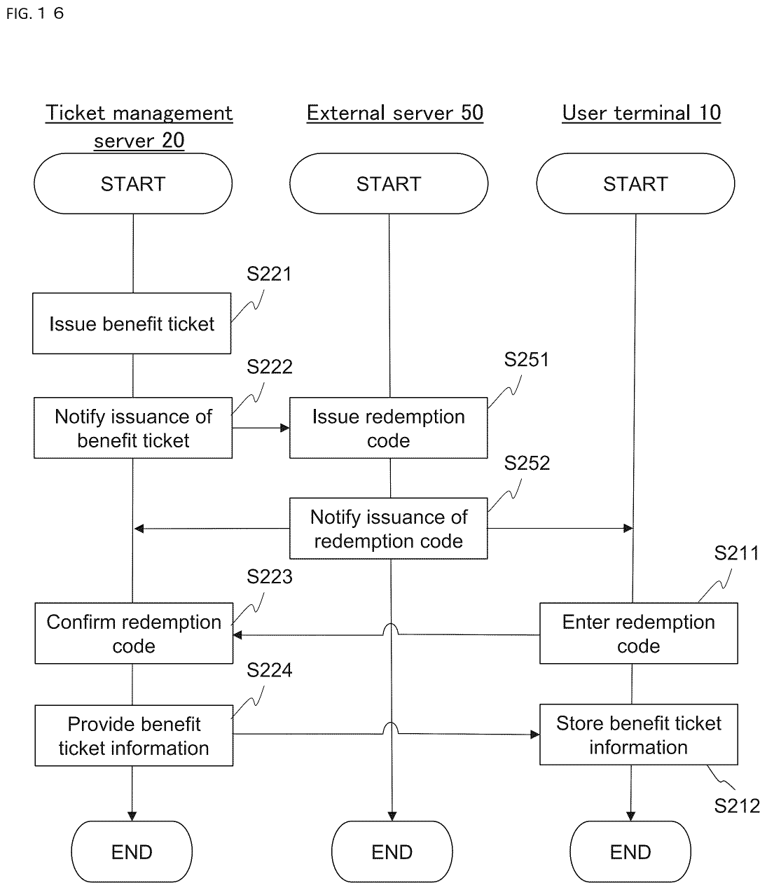

Next, processing for the user to redeem the benefit ticket will be described. FIG. 16 is a flowchart of processing for the user to redeem the benefit ticket.

As shown in FIG. 16, in the processing for the user to redeem the benefit ticket, first, the ticket management server 20 issues a benefit ticket (step S221). The benefit ticket is issued, for example, at the timing when the holding of a future event is specifically decided.

At this time, a benefit ticket database is created in the ticket management server 20. At this point in time, the “redemption code” field and the “owner ID” field in the benefit ticket database are blank. At this point in time, the “status” fields in the benefit ticket database shown in FIG. 15A are all “before redemption”.

As shown in FIG. 16, after step S221, the ticket management server 20 notifies the external server 50 of the issuance of the benefit ticket (step S222). Specifically, the processor 22 of the ticket management server 20 outputs to the external server 50 that the benefit ticket has been issued.

After step S222, the external server 50 issues a redemption code (step S251). Specifically, the external server 50 receives the notification of the issuance of the benefit ticket from the ticket management server 20, and creates the redemption code database shown in FIG. 15B. At this time, the redemption code database is created such that the redemption code is assigned to the ledger ID.

After step S251 shown in FIG. 16, the external server 50 notifies the ticket management server 20 and the user terminal 10 of the issuance of the redemption code (step S252). Specifically, the external server 50 notifies the ticket management server 20 of the redemption code. The ticket management server 20 thereby assigns the redemption code to the ticket ID of the benefit ticket in the benefit ticket database. As a result, the redemption code is recorded in the “redemption code” field in the benefit ticket database shown in FIG. 15A. The redemption code is thereby assigned so as to correspond to a seat number in the benefit ticket database. Note that the seat number may be assigned to the redemption code by using an input of a redemption code or the end of the reception thereof, which will be described later, as a trigger. Alternatively, the user may select a seat number when entering a redemption code, for example, on a first-come, first-served basis. Alternatively, it is possible to set a deadline for accepting redemption codes, and after the deadline has passed, the tickets for redemption may be assigned collectively by lottery.

In step S252 shown in FIG. 16, the external server 50 notifies the user terminal 10 of the issuance of the redemption code and the redemption code corresponding to the user. Specifically, the external server 50 notifies the user recorded as the owner of the token in the ledger ID of the redemption code corresponding to the ledger ID. This allows the user to redeem the benefit ticket.

The redemption code is notified by contacting the user s contact address (for example, email address) described in the account information database (see FIG. 9A) managed by the external server 50. The redemption code may be displayed on the user terminal 10 when the user logs in to the external server 50 using the external server login ID and the external server login PASS.

As a method for managing the redemption codes, the redemption codes may be written on a ledger (blockchain) managed by the token management ledger 40.

After step S252, the user inputs the redemption code notified to the user terminal 10 (step S211). Specifically, the user operates the user terminal 10 to log in to the ticket management server 20, and enters the notified redemption code. In this way, an application for redemption of the benefit ticket is made.

After step S211, the ticket management server 20 confirms the redemption code entered by the user (step S223).

Specifically, the processor 22 of the ticket management server 20 refers to the benefit ticket database to confirm whether or not the redemption code is appropriate.

After step S223, the ticket management server 20 provides benefit ticket information (step S224). Specifically, when the redemption code entered by the user is appropriate, the processor 22 records the user ID of the user in the “owner ID” field of the corresponding benefit ticket in the benefit ticket database. The owner of the benefit ticket is thereby recorded in the benefit ticket database. At this time, the “status” field in the benefit ticket database is rewritten from “before redemption” to “before use”.

Then, the processor 22 generates information on the benefit ticket (benefit ticket information) and provides it to the user terminal 10. Some or all of the information included in the benefit ticket information may be encoded in, for example, a QR code (registered trademark) or other code information.

After step S224, the user terminal 10 stores the benefit ticket information (step S212).

Specifically, the processor 12 of the user terminal 10 acquires the benefit ticket information provided in step S224. The processor 12 stores the acquired benefit ticket information in the storage device 11. As a result, the processor 12 can display the benefit ticket information as necessary. This completes the benefit ticket redemption processing.

In the example described above, the redemption codes are managed by the external server 50, but the present disclosure is not limited to this mode. For example, the redemption codes may be managed on each ledger (blockchain) managed by the token management ledger 40. In this case, the redemption processing may be performed by transferring the ownership of the token. That is, the redemption right may be erased by rewriting the information indicating the owner of the token from the user to the promoter on the blockchain. In this case, the user may apply for the redemption of the benefit not by entering the redemption code but by sending the token to the promoter (transfer of the blockchain).

Further, the ticket management server 20 that manages benefit tickets may be implemented by a server different from the ticket management server 20 that manages the serial codes for granting tokens. This is because it is more useful and realistic to use different servers given the period from when the first event is held to when the future event is held.

Further, a new token may be granted to the user again by the use of the benefit ticket. In this case, the token ID and the serial code are managed in the ticket database shown in FIG. 15A, and the processing from the use of the ticket to the token granting described above is performed after the use of the benefit ticket.

In addition, the benefit ticket may be a paper ticket, and the benefit granted using a token as a voucher may be a tangible object. For example, the benefit is a highly rare item such as official merchandise (such as an autograph) in a limited quantity. That is, the owner of the token is certified to have participated in a given event. In return for participation in the event, a benefit in kind, which is not digital information such as an electronic ticket, is provided.

Further, the ticket management server 20 grants an additional token when the token ownership state satisfies a predetermined condition set in advance. The additional token is a token that is additionally granted to those who participated in all events set as a predetermined series such as tour performances and own all the corresponding tokens. Owning an additional token is proof of full participation in a given series of events. Therefore, the additional token appeals to fans' (users') willingness to collect.

### (6) SCREEN EXAMPLES

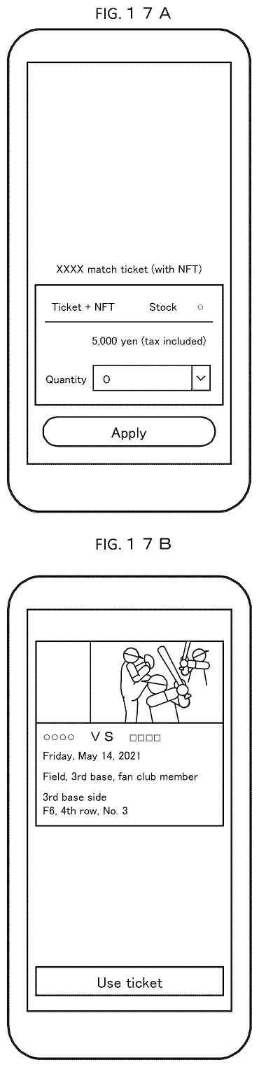

Next, screen examples of the user terminal 10 in the system 1 will be described. The first screen example shown in FIG. 17A is a screen example when a ticket is purchased (step S110 in FIG. 12).

As shown in FIG. 17A, when a ticket is purchased, the event description, the purchase object, and the price are displayed. The user enters the number of tickets and makes a purchase application, thereby making a purchase.

The second screen example shown in FIG. 17B is a screen example when a ticket has been issued and ticket information is stored (step S113 in FIG. 12).

As shown in FIG. 17B, when the ticket information is stored, the description of the purchased ticket is displayed on the user terminal 10. This allows the user to confirm that the purchase has been made properly.

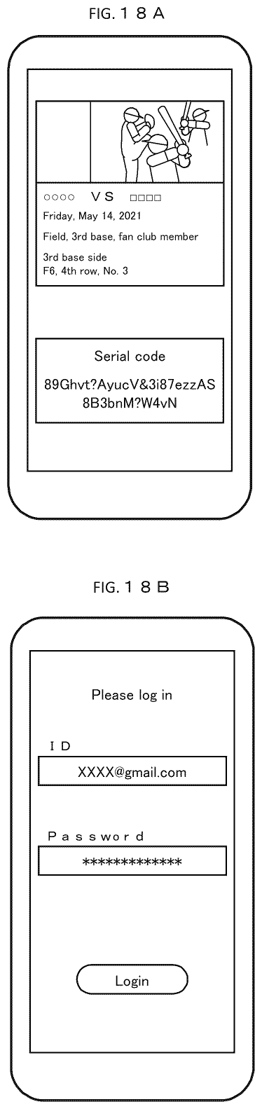

The third screen example shown in FIG. 18A is a screen example when a serial code for applying for granting of a token is received (step S115 in FIG. 14).

As shown in FIG. 18A, upon receipt of the serial code, the serial code is displayed on the user terminal 10.

Note that the serial code may be sent by SMS to an email address or a telephone number registered in the user registration. The serial code may also be sent on the My Page that is displayed when the user logs in to the ticket management server 20.

The serial code may be sent by issuing a new ticket on which the serial code number is written. That is, when a serial code is issued, a ticket ID as a serial code ticket may be granted and recorded as a new record in the ticket database. As a result, the received serial code itself can be circulated in the same manner as “tickets” and, for example, becomes an object of a transaction between users, thereby increasing its versatility.

When the serial code ticket is issued, the serial code may not be directly displayed, but an operation corresponding to the “ticket collection” process may be executed, such as tapping the use button in the same manner as an entry ticket. This will ensure that the serial code is “unused” by allowing the serial code to be displayed only when the ticket itself is “used”.

The fourth screen example shown in FIG. 18B is an example of a login request screen which is displayed before the transition to a predetermined form screen in order to receive a token. When the user logs in by entering a login ID and a password, a predetermined form screen for entering a serial code is displayed.

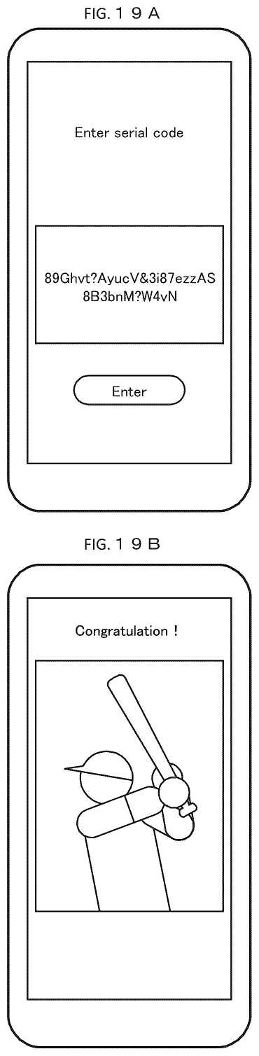

The fifth screen example shown in FIG. 19A is a screen example when a serial code is entered (step S116 in FIG. 14).

As shown in FIG. 19A, the user enters the serial code into a given input field displayed and clicks the enter button.

The sixth screen example shown in FIG. 19B is a screen example when the owner of the token is recorded (step S125).

As shown in FIG. 19B, when the owner of the token is recorded, a message to that effect is displayed to the user who has entered the serial code, and a benefit image (in this example, an image of a professional baseball player) as a digital content constituting the token is displayed.

### (7) ADVANTAGEOUS EFFECTS

As described above, the ticket system 1 can provide content data that is a benefit to the user based on the actual use of the ticket (i.e., visiting the event venue or viewing the event online). This means that one cannot purchase a ticket to obtain a benefit and then resell the ticket after obtaining the benefit; one must actually use the ticket to participate in the event. This can effectively motivate people to participate in the event.

Further, since the identity of the purchaser and the user of the ticket is confirmed, it is possible to effectively prevent ticket hoarding and resale for the purpose of receiving tokens.

In addition, since the identity of the owner and the user of the ticket is confirmed using the captured image of the face of the owner of the ticket, it is difficult for someone to pretend to be the owner of the ticket and use the ticket, and the accuracy of the confirmation result can be ensured.

Further, since an identifier is issued to the owner of the token and then, the token is granted by receiving an entry of the identifier, it is possible to effectively prevent unauthorized acquisition of the token by another person.

In addition, since the tokens can be individually traded between users, the motivation to collect tokens can be improved.

The value of the tokens can be further enhanced by offering benefits such as tickets to events to those who own the tokens.

In addition, since an additional token is granted when the token ownership state satisfies a predetermined condition, it is possible to more effectively improve the willingness to collect tokens and, in turn, the willingness to participate in the event.

### (8) MODIFICATIONS

Modifications of the present embodiment will be described.

### (8-1) First Modification

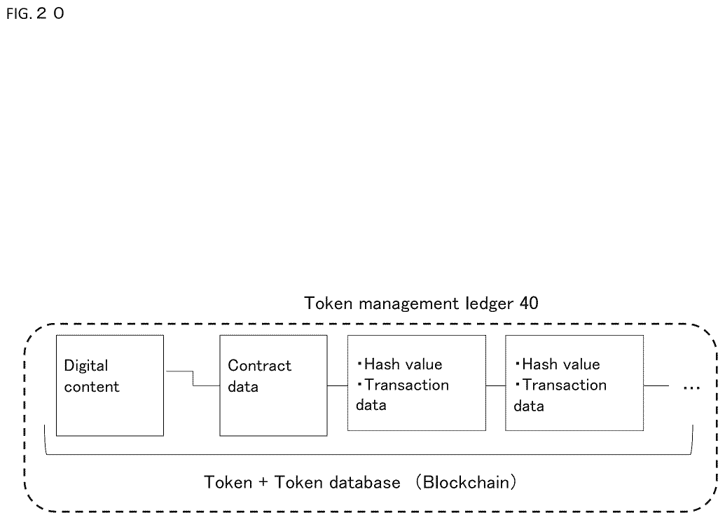

In the first modification, the content data as a token is different from that in the above-described embodiment. FIG. 20 is a diagram showing another structure example of the content data.

As shown in FIG. 20, the content data according to the modification is incorporated as a part of the blockchain. In this case, the information as the token and the token management ledger 40 is recorded in the distributed management ledger as a blockchain.

### (8-2) Second Modification

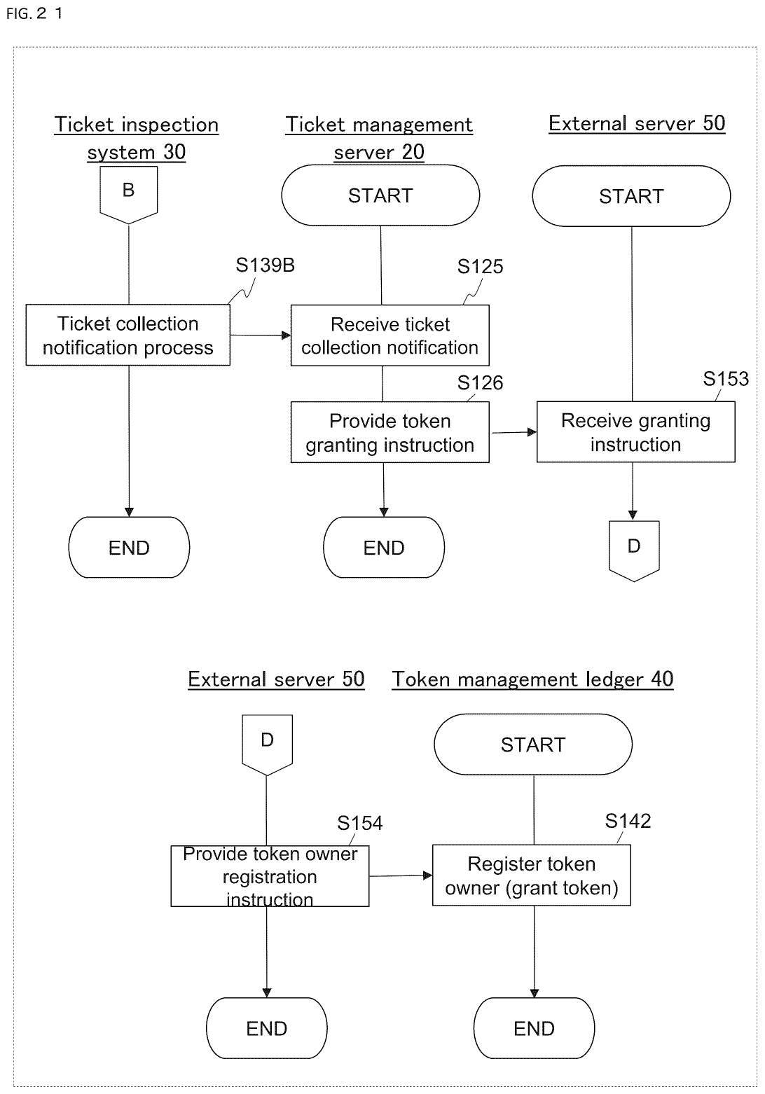

In the second modification, an example of granting a token without granting a serial code will be described. FIG. 21 is a diagram illustrating token granting processing according to the second modification. In this modification, the user ID of the external server 50 is stored in the user database. The flow up to the ticket inspection processing is the same as that in the embodiment, and a description thereof will be omitted.

As shown in FIG. 21, the ticket inspection system 30 performs a ticket collection notification process (step S139B). Specifically, the ticket inspection system 30 transmits to the ticket management server 20 that the ticket has been used.

After step S139B, the ticket management server 20 receives a ticket collection notification (step S125). At this time, the ticket management server 20 updates the “status” field of the ticket database to “used” for the ticket based on the ticket collection notification.

After step S125, the ticket management server 20 executes a token granting instruction. (step S126) At this time, the ticket management server 20 uses the token ID associated with the ticket and the login ID in the external server 50 associated with the user who is the owner of the ticket to transmit the token granting instruction to the external server 50.

After step S126, the external server 50 receives the token granting instruction (step S153).

After step S153, the external server 50 transmits a token owner registration instruction to the token management ledger 40 (step S154). At this time, the external server 50 refers to the account information database to refer to the management ledger login ID and the management ledger PASS corresponding to the login ID in the external server 50. The external server 50 then logs in to the token management ledger 40 and provides an instruction to register the user for the token ID.

After step S152, the token management ledger 40 registers the owner of the token. At this time, the token management ledger 40 adds a block in which the user ID of the external server 50 is recorded as new transaction data on the blockchain.

This clarifies the owner of the token. In other words, through this processing, a token is granted to a user who has visited the event venue.

This completes the token granting processing.

### (9) OTHER MODIFICATIONS

The storage device 11 may be connected to the user terminal 10 via the network NW. The storage device 21 may be connected to the ticket management server 20 via the network NW. The storage device 31 may be connected to the ticket inspection system 30 via the network NW.

The ticket inspection processing may be performed by the ticket inspection system 30 alone as shown in FIG. 13, or may be performed in cooperation between the ticket inspection system 30 and another device (for example, the ticket management server 20).

In the embodiment, the identity of the ticket owner and the ticket user (visitor) is confirmed, and when the identity is confirmed, the token is granted to the ticket owner. However, the ticket system 1 may grant, without exception, the token to the owner after a certain period of time has elapsed after the ticket collection process has been performed by the ticket inspection system 30 without confirming the identity of the ticket owner and the ticket user (visitor). Alternatively, the token may be granted by the administrator providing an instruction about granting of a token to the ticket management server 20.

The identity of the owner of the ticket and the visitor may be confirmed at a timing before the application for granting of a serial code (step S139), instead of when determining whether or not the entry is permitted (step S132).

The identity of the ticket owner and the visitor may be confirmed by other means such as identity authentication required when accessing ticket information. Specifically, the identity of the ticket owner and the visitor may be confirmed using user-specific information separately registered before the visit, such as account information that the user enters when having the ticket information displayed, SMS authentication, terminal ID authentication, the user s email address that is not managed in association with the user s account information, and the user's wallet information that is information for identifying the user on the blockchain (ledger).

The identity of the ticket owner and the visitor may be confirmed by displaying the face image acquired from the ticket owner on a part of the face of the electronic ticket (or on a transitioned screen from the face of the ticket) and having an attendant confirm the face image displayed on the face of the ticket and the face of the visitor at the ticket inspection station.

The identity of the ticket owner and the visitor may be confirmed by the confirmation of an identification document (such as a driver's license) by an attendant at the ticket inspection station.

In addition, when the identity of the visitor and the ticket owner is confirmed, wallet information of the user may be newly created using any one piece of the user-specific information used to confirm the identity of the visitor and the ticket owner. The created wallet information may be recorded in the ledger as the owner of the token, thereby granting the token in step S141.

The identity of the visitor and the ticket owner may be confirmed by the account information (account ID) of the user, and wallet information may be newly created using the email address stored in association with the account ID.

In the embodiment, the mode in which the user visits the event venue has been described. However, for example, when the event is an online event, the user presses a viewing button displayed on the user terminal 10, whereby the ticket display processing (step S114) shown in FIG. 13 is executed.

That is, when the ticket relates to an event provided via information communication, the user s use of the ticket to receive the provision of information communication is referred to as the use of the ticket, and the use of the ticket is detected by the start of the provision of information communication.

Further, the ticket inspection system 30 determines whether or not viewing is permitted, instead of determining whether or not entry is permitted (step S132 shown in FIG. 13). In this case, instead of the visible light camera 352 of the ticket inspection system 30, a process of transmitting the face picture of the viewer captured by the user terminal 10 to the ticket inspection system 30 may be performed.

In the embodiment, an example of determining whether or not the visitor's entry is permitted using a facial feature has been described, but it is also possible to determine whether or not the visitor's entry is permitted using a feature relating to other biometrics (for example, a finger print, a palm print, an iris, a vein, a myoelectric potential, or the like) in place of the facial feature.

In addition, user-specific information may be acquired by another sensor such as an infrared sensor, an RFID sensor, a sonic sensor, or a laser-type one-dimensional barcode reader.

Alternatively, whether or not the visitor's entry is permitted may be determined using a plurality of types of features.

Although the process of acquiring a feature at the time of user registration has been described in the embodiment, the timing of acquiring a feature is not limited to this. For example, after the ticket is issued, a process of transitioning from the ticket face displayed on the user terminal 10 to a screen for entering a feature may be performed.

Alternatively, after the ticket is purchased and before the ticket is issued, a feature acquired by the user terminal 10 may be entered.

In the embodiment, a configuration in which a blockchain is used as the token management ledger 40 has been described, but the present disclosure is not limited to such a mode. That is, the token management ledger 40 may be a database consisting of columns necessary to manage tokens.

In the embodiment, an example in which the ticket is an authentication information carrier that carries authentication information has been described. However, the authentication information carrier may be the visitor's living body. Specifically, the authentication information carrier may be the face of the visitor or the palm of the visitor. Such an authentication information carrier holds information on a feature of the visitor as authentication information. In this case, the ticket inspection system 30 can acquire a feature of the visitor and identify the ticket ID for identifying the ticket purchased by the visitor using the feature as a clue. That is, the ticket database stores the biometric information (including a feature) of the user who purchased the ticket in place of the ticket ID.

In the embodiment, an example in which the ticket management server 20 transmits the ticket information to the user terminal 10 has been described. However, instead of the ticket information, the ticket management server 20 may transmit to the user terminal 10 resource information (e.g., a uniform resource locater (URL)) for referring to the resource in which the ticket information is stored. The visitor can have the ticket information displayed on the display of the user terminal 10 by accessing the resource indicated by the resource information through the user terminal 10 of the visitor.

In the embodiment, an example in which a feature of the purchaser is transmitted to the ticket management server 20 at the time of ticket purchase has been described. However, the feature of the purchaser may be transmitted to the ticket management server 20 after ticket purchase. This makes it possible to collectively purchase tickets for a plurality of visitors. The deadline for transmitting the feature of the visitor to the ticket management server 20 may be set, and the content of the ticket inspection processing may differ between the case where the ticket for which the feature has been registered within the deadline is presented and the case where the ticket without the feature registered is presented.

In the embodiment, an example in which part or all of the information included in the ticket information is encoded in a two-dimensional code including, for example, a QR code (registered trademark) or other code information has been described. As an example, the ticket may include a QR code (registered trademark) including a ticket ID and a reference character string.

During the ticket issuance processing, the processor 22 of the ticket management server 20 generates a reference character string by performing an operation of a predetermined function using, for example, a ticket ID, an event ID (information for identifying an event which the ticket is for), and a facial feature of the purchaser of the ticket as arguments.

The storage device 31 of the ticket inspection system 30 stores a performance ID corresponding to the performance a ticket for which is to be inspected and the above function. During the ticket inspection processing, the processor 32 of the ticket inspection system 30 generates an authentication target character string by performing an operation of the function read from the storage device 31 using the ticket ID read from the ticket, the performance ID read from the storage device 31, and the facial feature of the ticket user as arguments. The ticket inspection system 30 compares the reference character string read from the ticket with the authentication target character string, thereby determining the identity of the user and the owner of the ticket.

According to this example, unauthorized resale of tickets can be suppressed without storing the personal information of the user in the storage device 31 of the ticket inspection system 30.

In the embodiment, a process in which a serial code is granted by the ticket management server 20 has been described, but the present disclosure is not limited to this.

For example, a serial code may written in a non-displayed state in ticket data downloaded in advance in the user terminal 10 and a process of displaying the serial code may be performed in the user terminal 10 in response to execution of ticket collection by the ticket inspection system 30.

The embodiment of the present invention has been described above, but the scope of the present invention is not limited to the above-described embodiment. In addition, the above-described embodiment can be improved or modified in various ways without departing from the gist of the present invention. The above-described embodiment and modifications may be combined, or a part thereof may be omitted.

1. An apparatus comprising processing circuitry configured to:
detect use of a ticket; and
grant a token whose ownership can be clarified to an owner of the ticket in response to the detection of the use of the ticket.

2. The apparatus according to claim 1, wherein
in detecting use of a ticket, the processing circuitry configured to
detect the use of the ticket by detecting that a user of the ticket is permitted to enter an event venue where an event related to the ticket is held.

3. The apparatus according to claim 1, wherein
in detecting use of a ticket, the processing circuitry configured to detect the use of the ticket by detecting that a user of the ticket has started online viewing of video or audio related to the ticket.

4. The apparatus according to claim 1, wherein
in granting a token, when identity of a user of the ticket and the owner of the ticket is confirmed, the token is granted to the owner of the ticket.

5. The apparatus according to claim 4, wherein
in granting a token,
the identity of the user and the owner is confirmed by identity authentication that is required when accessing information of the ticket, and
when the identity of the user and the owner is confirmed, the token is granted to the owner of the ticket.

6. The apparatus according to claim 4, wherein
in granting a token,
the identity of the user and the owner is confirmed using a face image of the owner stored in advance and a face image of the user captured when the ticket is used, and
when the identity of the user and the owner is confirmed, the token is granted to the owner of the ticket.

7. The apparatus according to claim 1, wherein
in granting a token, the processing circuitry configured to:
transmit an identifier to the owner of the ticket; and
receive an input of the identifier from the owner.

8. The apparatus according to claim 7, wherein
in granting a token, the processing circuitry configured to
write the identifier on a face of the ticket.

9. The apparatus according to claim 1, wherein
in granting a token,
an owner of the token is registered in a server that menages the token in response to the use of the ticket, using a user ID in the server that manages the token, the user ID being associated with a user ID in a server that manages information of the ticket.

10. The apparatus according to claim 1, further causing the processing circuitry configured to:
in response to an instruction from an owner to whom the token is granted, change the owner of the token to another user.

11. The apparatus according to claim 1, the processing circuitry further configured to:
identify a user who owns the token; and
provide a benefit to the user who owns the token, using the token as a voucher.

12. The apparatus according to claim 1, the processing circuitry further configured to:
identify a user whose token ownership state satisfies a predetermined condition; and
grant an additional token to the user whose token ownership state satisfies the predetermined condition.

13. A method to be executed by a computer including a processing circuitry, the method causing the processing circuitry to perform:
detect use of a ticket; and
grant a token whose ownership can be clarified to an owner of the ticket in response to the detection of the use of the ticket.

14. A system comprising a processor:
the processor configured to;
detect use of a ticket; and
grant a token whose ownership can be clarified to an owner of the ticket in response to the detection of the use of the ticket.

15. The system according to claim 14, wherein
the token is associated with a management ledger on which a transaction history can be referred to.

16. The system according to claim 14, wherein
the token is managed by a distributed management ledger.
